(19) United States
(12) Patent Application Publication
(10) Pub. No.: US 2019/0394001 A1
(43) Pub. Date: Dec. 26, 2019

(54) BASE STATION AND USER APPARATUS

(71) Applicant: NTT DOCOMO, INC., Tokyo (JP)

(72) Inventors: Yousuke Sano, Tokyo (JP); Kazuki Takeda, Tokyo (JP); Satoshi Nagata, Tokyo (JP)

(73) Assignee: NTT DOCOMO, INC., Tokyo (JP)

(21) Appl. No.: 16/481,784

(22) PCT Filed: Jan. 22, 2018
(86) PCT No.: PCT/JP2018/001819

§ 371 Date: Jul. 29, 2019

(30) Foreign Application Priority Data
Feb. 3, 2017 (JP) 2017-019117

(51) Int. Cl. H04L 5/00

(52) U.S. Cl. CPC H04L 5/0048; H04L 5/0042; H04L 5/0007

(57) ABSTRACT

Transmission and reception techniques for reference signals to implement proper precoding gain and channel estimation accuracy are disclosed. One aspect of the present invention relates to a base station, comprising: a communication control unit configured to control radio communication with a user apparatus; and a reference signal processing unit configured to indicate a reference signal configuration for each resource assignment unit to the user apparatus and transmit a reference signal to the user apparatus in accordance with the indicated reference signal configuration.

### TECHNICAL FIELD

The present invention relates to a radio communication system.

### BACKGROUND ART

Presently, specifications for a fifth generation (5G) or NR (New RAT) system are being designed as a next radio communication system of LTE (Long Term Evolution) and LTE-Advanced. In the NR, it is required to further improve spectral efficiency compared with the LTE.

In the LTE, a PCFICH (Physical Control Format Indicator Channel), a PHICH (Physical Hybrid ARQ Indicator Channel) and a PDCCH (Physical Downlink Control Channel) are assigned in a downlink control channel area, and resource assignment is performed by using a resource element group (REG) consisting of four resource elements (REs) as a minimum unit. For example, in the case where 2Tx and 3 OFDM symbols are assigned in the downlink control channel area (CFI (Control Format Indicator)=3), the resource element groups are arranged as illustrated in FIG. 1. In the illustrated example, eight resource element groups are included in one resource block.

In the PDCCH in the LTE, DCI is transmitted to respective connecting user apparatuses. The PDCCH is mapped to radio resources other than the PCFICH and the PHICH in radio resources consisting of one or more OFDM (Orthogonal Frequency Division Multiplexing) symbols from a start symbol specified in the CFI in each subframe. The minimum assignment unit of the PDCCH in the LTE is a CCE (Control Channel Element). In order to assign the PDCCH, the resource element groups other than the resource elements assigned for the PCFICH and the PHICH are numbered as illustrated in the example in FIG. 2 (the case of CFI=2), and nine consecutive resource element groups (referred to as CCEs) are the minimum assignment unit of the PDCCH.

### SUMMARY OF INVENTION

### Problem to be Solved by the Invention

In the NR, as illustrated in FIG. 3, it is agreed that PDCCH candidates are composed of multiple CCEs and the respective CCEs are composed of multiple REGs. Also, it is agreed that each REG is one resource block within one OFDM symbol. In other words, the PDCCH in the NR is assigned based on the CCE and the REG as defined in this manner.

As illustrated in FIG. 4, the REG may include a reference signal (RS) and a data symbol. Then, the optimal reference signal configuration may be different depending on channel environments. As a result, it is desired that the flexible reference signal configuration allows the number of inserted reference signals and/or mapping patterns to be selected in the frequency direction and/or the time direction. For example, as illustrated in FIG. 5, frequency selectivity may be utilized through adjustment of transmission density of the reference signals in the frequency direction.

Taking a frequency selective channel (and channel selectivity for a time domain) into account, the optimal transmission precoding matrix may be different for respective REGs or CCEs. In order to improve performance of the PDCCH in the NR system, as illustrated in FIG. 6, it is useful for different transmission precodings to be applied to the respective REGs or CCEs. On the other hand, channel estimation accuracy can be improved by applying the same transmission precoding to multiple REGs and CCEs. Specifically, a channel estimation error (noise factor) can be alleviated through averaging the reference signal, and it is known that channel selectivity in a frequency/time domain and/or application of different transmission precodings may lower the channel estimation accuracy. In this fashion, the application of different transmission precodings leads to a higher precoding gain but lowers the channel estimation accuracy. On the other hand, the application of the same transmission precoding leads to a lower precoding gain but improves the channel estimation accuracy.

As illustrated in FIG. 7, there is discussion of the transmission precoding being applied with different granularities. In the case where the precoding granularity is one REG, as illustrated in FIG. 7A, the channel estimation (CE) is performed based on the two reference signals transmitted within each CE window. On the other hand, in the case where the precoding granularity is two REGs, as illustrated in FIG. 7B, the channel estimation (CE) is performed based on the four reference signals transmitted within each CE window, and higher channel estimation accuracy can be achieved. In this case, on the other hand, user apparatuses need to know the reference signal configuration to perform appropriate channel estimation.

In light of the above problems, an object of the present invention is to provide transmission and reception techniques for reference signals to achieve appropriate precoding gain and channel estimation accuracy.

### Means for Solving the Problem

In order to overcome the above problem, one aspect of the present invention relates to a base station, comprising: a communication control unit configured to control radio communication with a user apparatus; and a reference signal processing unit configured to indicate a reference signal configuration for each resource assignment unit to the user equipment and transmit a reference signal to the user apparatus in accordance with the indicated reference signal configuration.

### Advantage of the Invention

According to the present invention, the transmission and reception techniques of reference signals to achieve appropriate precoding gain and channel estimation accuracy can be provided.

### BRIEF DESCRIPTION OF DRAWINGS

FIG. 1 is a diagram for illustrating exemplary assignment of resource element groups (REGs) in the LTE;

FIG. 2 is a diagram for illustrating exemplary assignment of control channel elements (CCEs) for a PDCCH in the LTE;

FIG. 3 is a diagram for illustrating exemplary assignment of REGs and CCEs for a PDCCH in the NR;

FIG. 4 is a diagram for illustrating exemplary assignment of a reference signal and a data symbol in the REG;

FIG. 5 is a diagram illustrating various reference signal configurations;

FIG. 6 is a diagram for illustrating exemplary precoding for the REG/CCE;

FIG. 7 is a diagram for illustrating exemplary assignment of reference signals with different precoding granularities;

FIG. 8 is a schematic diagram for illustrating a radio communication system according to one embodiment of the present invention;

FIG. 9 is a block diagram for illustrating a functional arrangement of a base station according to one embodiment of the present invention;

FIG. 10 is a diagram for illustrating a reference signal configuration according to one embodiment of the present invention;

FIG. 11 is a block diagram for illustrating a functional arrangement of a user apparatus according to one embodiment of the present invention;

FIG. 12 is a diagram for illustrating a reference signal configuration according to one embodiment of the present invention;

FIG. 13 is a diagram for illustrating a reference signal configuration according to one embodiment of the present invention;

FIG. 14 is a diagram for illustrating a reference signal configuration according to one embodiment of the present invention; and

FIG. 15 is a block diagram for illustrating a hardware arrangement of a user apparatus and a base station according to one embodiment of the present invention.

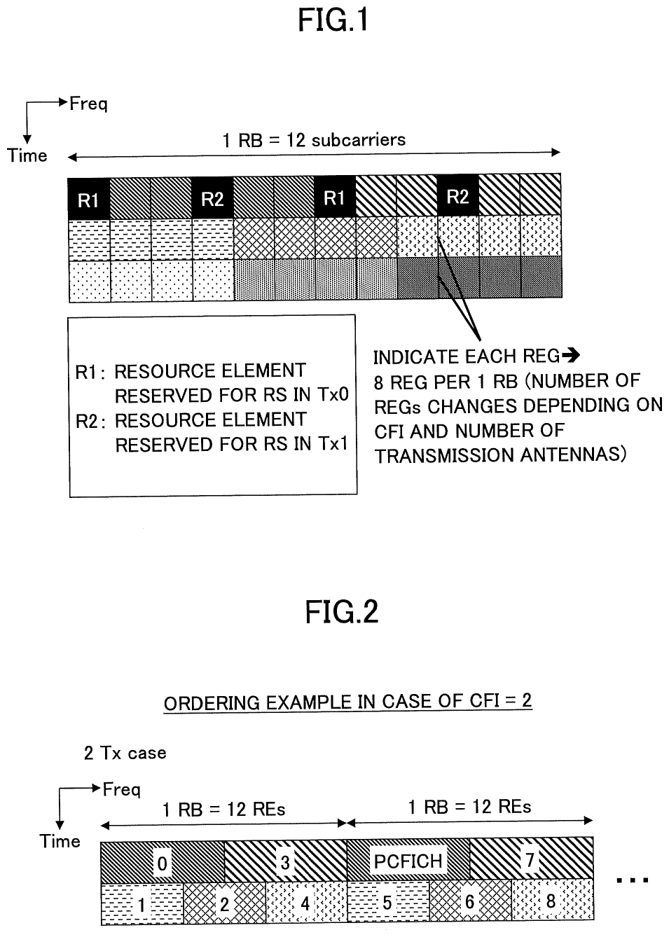

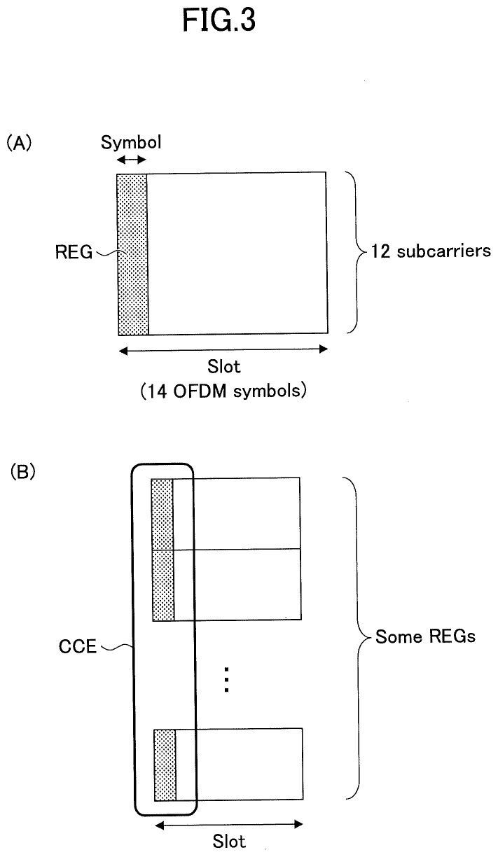

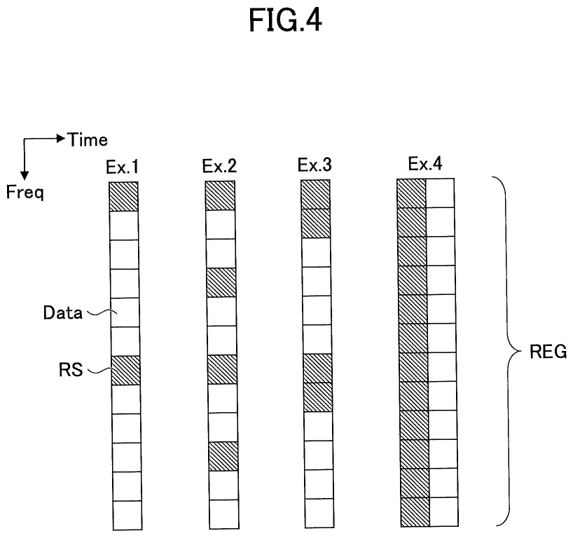

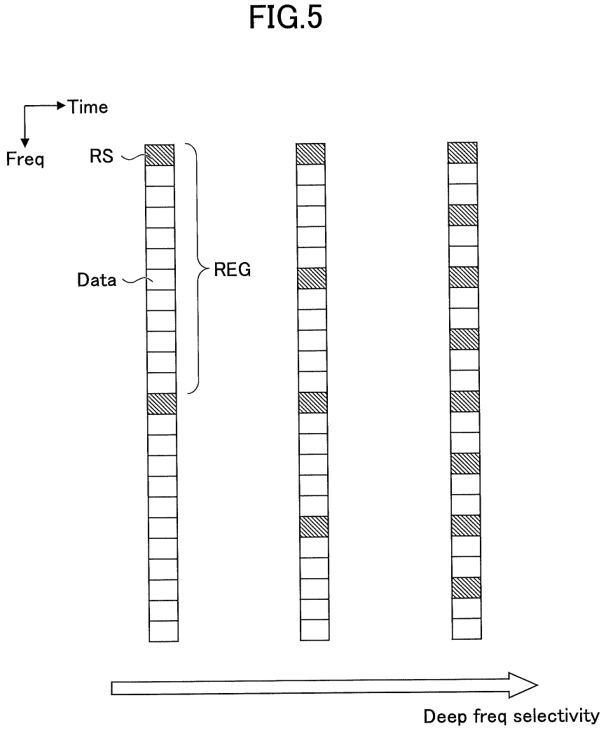

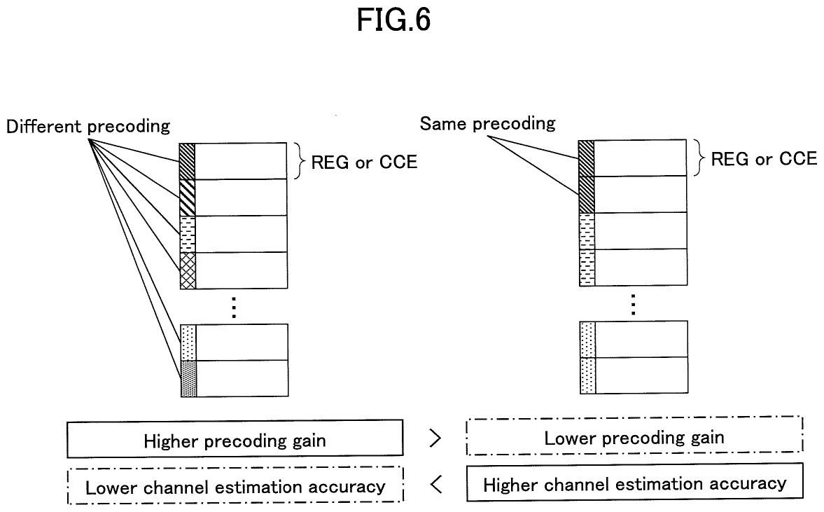

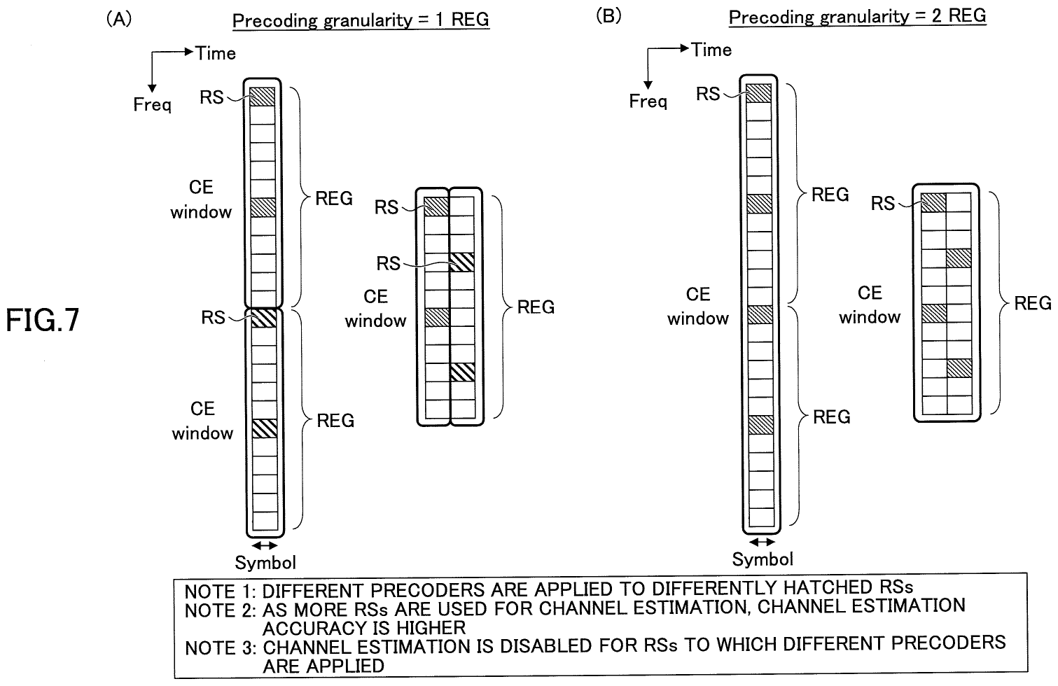

### EMBODIMENTS OF THE INVENTION

Embodiments of the present invention are described below with reference to the drawings.

In the following embodiments, a user apparatus and a base station for transmitting and receiving a precoded reference signal are disclosed. According to embodiments as described below, the base station indicates to the user apparatus a specific reference signal configuration for each resource assignment unit such as a REG or a CCE or a common reference signal configuration for all resource assignment units and transmits a reference signal, for which the same transmission precoding or different transmission precodings are applied to resource assignment unit in accordance with the indicated reference signal configuration, to the user apparatus. Upon receiving the reference signal configuration, the user apparatus receives the precoded reference signal in accordance with the received reference signal configuration and decodes the received reference signal with the corresponding precoding vector.

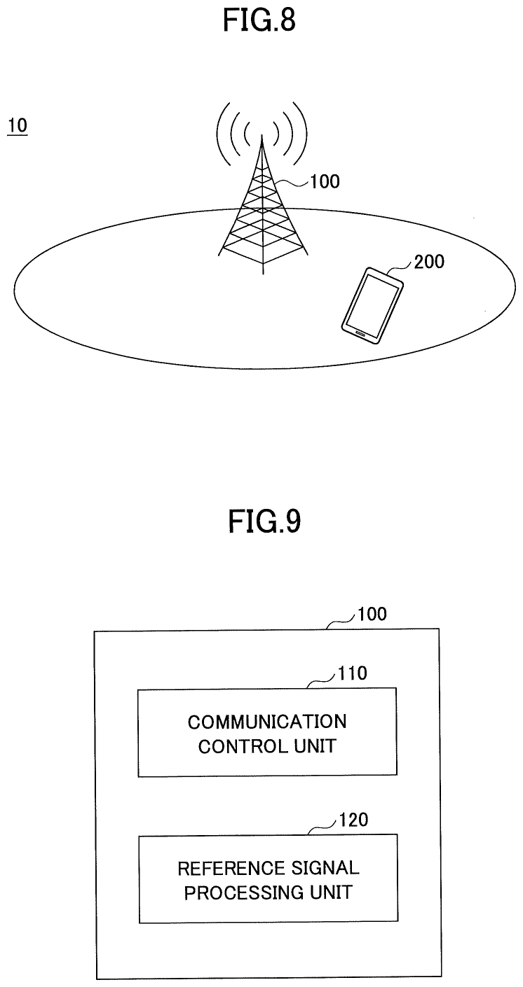

At the outset, a radio communication system according to one embodiment of the present invention is described with reference to FIG. 8. FIG. 8 is a schematic diagram for illustrating a radio communication system according to one embodiment of the present invention.

As illustrated in FIG. 8, a radio communication system 10 has a base station 100 and a user apparatus 200. In the following embodiments, the radio communication system 10 is a radio communication system compliant with standards subsequent from 3GPP Rel-14 (for example, a 5G or NR system). However, the present invention is not limited to it, and it may be any other radio communication system to which precoded reference signals are transmitted and received.

The base station 100 serves one or more cells for radio communication with the user apparatus 200. In the illustrated embodiment, only the single base station 100 is illustrated, but a large number of base stations 100 are generally disposed to cover a service area of the radio communication system 10.

The user apparatus 200 is any appropriate information processing device with radio communication functionalities such as a smartphone, a mobile phone, a tablet, a wearable terminal and a communication module for M2M (Machine-to-Machine), and the user apparatus 200 wirelessly connects to the base station 100 to use various communication services served from the radio communication system 10.

In the present embodiment, precoded reference signals and data symbols are transmitted in each REG or CCE. The same precoding is applied to the reference signals and the data symbols within a channel estimation (CE) window, and the user apparatus 200 performs channel estimation based on the reference signal received within the same CE window.

Next, a base station according to one embodiment of the present invention is described with reference to FIG. 9. FIG. 9 is a block diagram for illustrating a functional arrangement of the base station according to one embodiment of the present invention.

As illustrated in FIG. 9, the base station 100 has a communication control unit 110 and a reference signal processing unit 120.

The communication control unit 110 controls radio communication with the user apparatus 200. Specifically, the communication control unit 110 assigns various radio signals such as a downlink/uplink control signal and a downlink/uplink data signal to radio resources and performs downlink and uplink communication with the user apparatus 200 in the assigned radio resources. Also, the communication control unit 110 precodes a to-be-transmitted radio signal in accordance with a precoding matrix and transmits the precoded radio signal to the user apparatus 200.

The reference signal processing unit 120 indicates a reference signal configuration in each resource assignment unit to the user apparatus 200 and transmits a reference signal to the user apparatus 200 in accordance with the indicated reference signal configuration. Specifically, the reference signal processing unit 120 indicates a reference signal configuration indicative of resource assignment of the reference signal in each REG or CCE to the user apparatus 200. The reference signal processing unit 120 may indicate the reference signal configuration with an upper layer signaling or a broadcast signal, for example. Then, the communication control unit 110 assigns the reference signal to resource elements in each REG or CCE in accordance with the indicated reference signal configuration, precodes the REG or the CCE including the assigned reference signal and transmits the precoded downlink signal to the user apparatus 200.

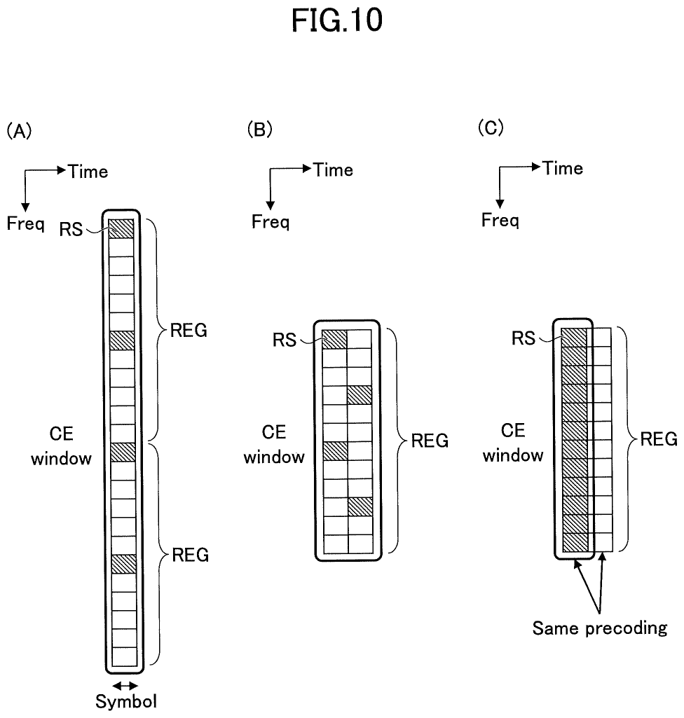

Specifically, as illustrated in FIG. 10, the reference signal configuration indicates assignment positions for the reference signal in each REG or CCE and can specify resource assignment of the reference signal for the respective REGs or CCEs separately. In the case where each REG is composed of twelve resource elements, the reference signal may be transmitted at the illustrated resource element positions in the REG. For example, in the example as illustrated in FIG. 10A, a same transmission precoding is applied to two adjacent REGs with respect to the frequency direction, and the reference signal is transmitted at the illustrated resource element positions. In the example as illustrated in FIG. 10B, a same transmission precoding is applied to two adjacent REGs with respect to the time direction, and the reference signal is transmitted at the illustrated resource element positions distributed with respect to the frequency direction and the time direction. In the example as illustrated in FIG. 10C, a same transmission precoding is applied to two adjacent REGs with respect to the time direction, and the reference signal is transmitted at the illustrated resource element positions over the entire frequency direction. For example, the resource signal configuration may be represented with bitmap information indicative of presence of assignment of the reference signal in respective resource elements in each REG or CCE.

In one embodiment, the communication control unit 110 may apply a same transmission precoding to respective resource assignment units. Specifically, as illustrated in FIG. 10, the communication control unit 110 may apply the same transmission precoding to all REGs or CCEs. For a larger number of reference signals that are precoded with same transmission precoding, more reference signals are included in the CE window accordingly, which may improve channel estimation accuracy as stated above.

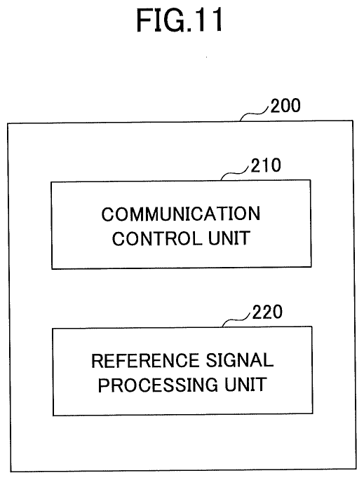

Next, a user apparatus according to one embodiment of the present invention is described with reference to FIG. 11. FIG. 11 is a block diagram for illustrating a functional arrangement of the user apparatus according to one embodiment of the present invention.

As illustrated in FIG. 11, the user apparatus 200 has a communication control unit 210 and a reference signal processing unit 220.

The communication control unit 210 controls radio communication with the base station 100. Specifically, the communication control unit 210 transmits and receives various radio signals such as a downlink/uplink control signal and a downlink/uplink data signal to and from the base station 100. Also, the communication control unit 210 receives a precoded radio signal from the base station 100 and decodes the received radio signal with the corresponding precoding vector.

The reference signal processing unit 220 receives a reference signal configuration in each resource assignment unit indicated from the base station 100 and receives a reference signal transmitted in accordance with the received reference signal configuration. For example, the reference signal configuration may be indicated with an upper layer signaling or a broadcast signal, and the reference signal processing unit 220 may receive precoded reference signals in resource elements indicated in the received reference signal configuration. As stated above, the reference signal configuration indicates assignment positions of the reference signal in each REG or CCE as illustrated in FIG. 10 and can specify resource assignment of the reference signal for the respective REGs or CCEs separately. For example, the reference signal configuration may be represented with bitmap information indicative of presence of assignment of the reference signal in respective resource elements in each REG or CCE.

In one embodiment, the reference signal processing unit 220 may receive the reference signal for which a same transmission precoding is applied to respective resource assignment units. As illustrated in FIG. 10, the base station 100 can apply a same transmission precoding to all REGs or CCEs. In this case, the reference signal processing unit 220 receives reference signals precoded with the same transmission precoding over all REGs or CCEs and performs channel estimation based on the received reference signals. For a larger number of reference signals that are precoded with same transmission precoding, more reference signals are included in a CE window accordingly, which improves the channel estimation accuracy as stated above.

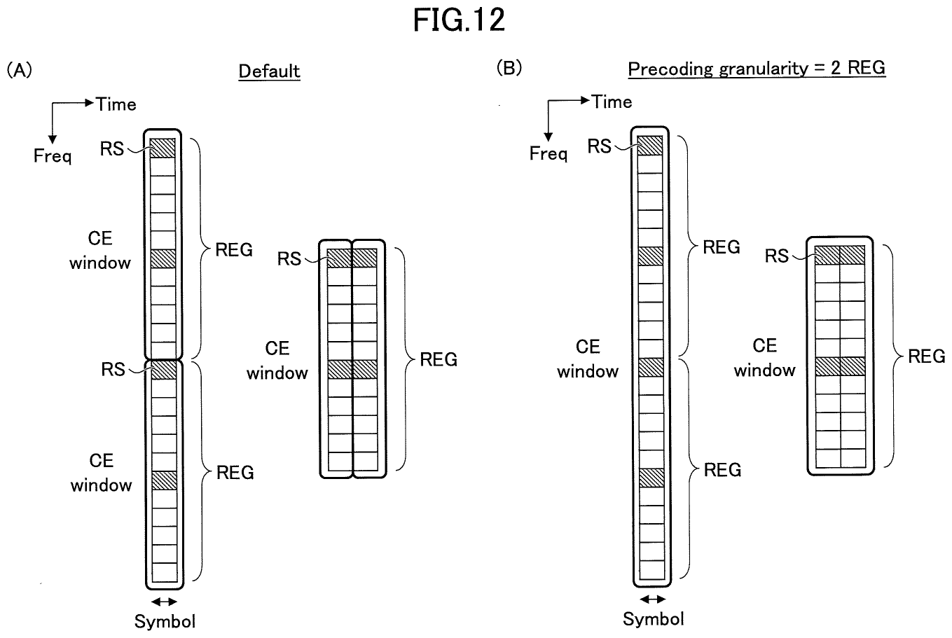

Also, in one embodiment, the reference signal processing unit 120 may apply a same reference signal configuration to respective resource assignment units. In this case, the reference signal processing unit 220 receives the reference signal for which the same reference signal configuration is applied to respective resource assignment units. Specifically, as illustrated in FIGS. 12A and 12B, the reference signal processing unit 120 may transmit the reference signal in accordance with the same reference signal configuration, that is, at same resource element positions in each REG. In the illustrated examples, the reference signal processing unit 120 transmits the reference signal at the same resource element positions with respect to the frequency direction in each REG composed of twelve resource elements. In this case, the reference signal processing unit 120 indicates the resource element positions for transmitting the reference signal as the reference signal configuration to the user apparatus 200. Upon receiving the reference signal configuration, the reference signal processing unit 220 receives the reference signal at the resource element positions indicated in the received reference signal configuration.

Note that the communication control unit 110 may apply different transmission precodings to respective resource assignment units. As a result, the respective resource assignment units are transmitted in different propagation channels, and reception characteristics may be improved due to diversity effect. In this case, the reference signal processing unit 220 receives the reference signal for which the different transmission precodings are applied to respective resource assignment units. Specifically, the different transmission precodings are applied to respective REGs by default (precoding granularity=1 REG). In this case, as illustrated in FIG. 12A, the user apparatus 200 performs channel estimation based on the reference signal for each REG or CCE.

On the other hand, in one embodiment, the precoding granularity may be dynamically configured, and the reference signal processing unit 120 may further indicate the precoding granularity to the user apparatus 200. For example, if channel frequency (or time) variations are large, the granularity of the frequency domain (or the time domain) may be made finer, and otherwise, the granularity may be made greater. As a result, the optimal channel estimation in accordance with channel frequency (or time) selectivity can be achieved. In this case, the reference signal processing unit 220 receives the reference signal transmitted in accordance with the precoding granularity indicated from the base station 100. Specifically, if the precoding granularity is configured with 2 REGs, as illustrated in FIG. 12B, the user apparatus 200 performs the channel estimation based on the reference signal for every two adjacent REGs with respect to the frequency direction or the time direction. Here, the precoding granularity may be indicated with an upper layer signaling or a broadcast signal. Also, the base station 100 may determine the precoding granularity based on feedback information from the user apparatus 200 or reference signals for UL channel quality measurement transmitted from the user apparatus 200.

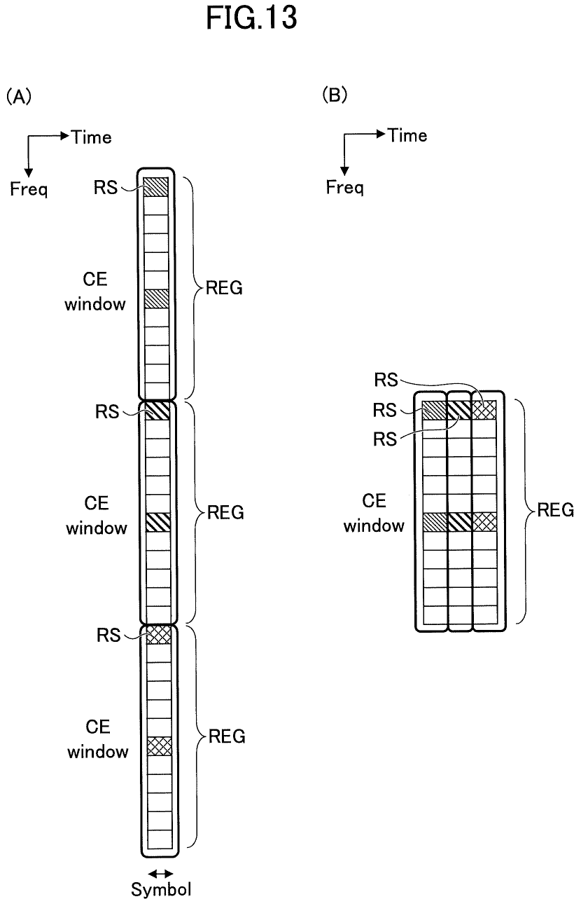

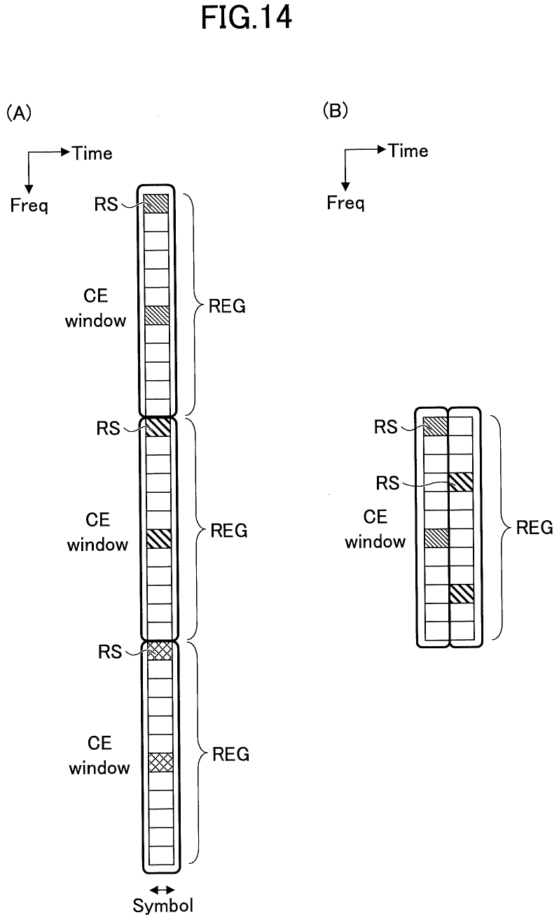

Also, as illustrated in FIGS. 13A and 13B, the reference signal processing unit 120 may apply a same reference signal configuration to respective REGs and indicate the reference signal configuration to the user apparatus 200, and the communication control unit 110 may apply different transmission precodings to three respective adjacent REGs with respect to the frequency direction (FIG. 13A) or the time direction (FIG. 13B). In this case, the reference signal processing unit 220 receives the reference signal at the same resource element positions in each REG in accordance with the reference signal configuration commonly configured for all the received REGs and decodes the reference signal received with a precoding vector applied to the respective REGs.

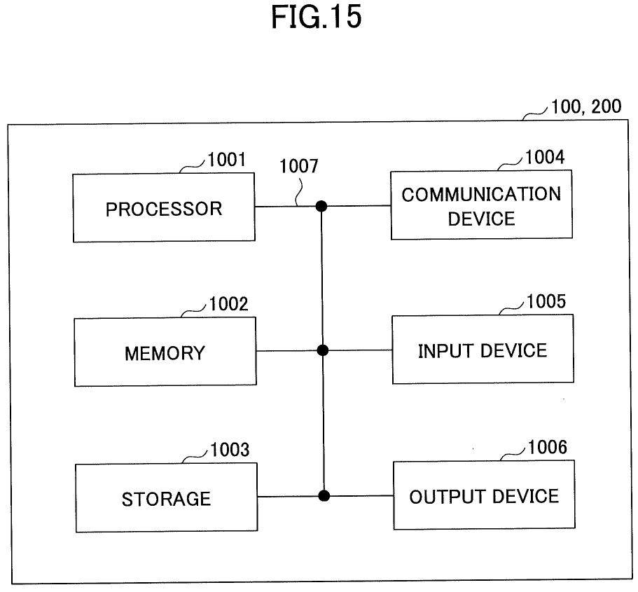

Also, as illustrated in FIGS. 14A and 14B, the reference signal processing unit 120 may apply a specific reference signal configuration for each REG (FIG. 14B) and indicate the reference signal configuration to the user apparatus 200, and the communication control unit 110 may apply the different transmission precodings to the respective adjacent REGs with respect to the frequency direction or the time direction. In this case, the reference signal processing unit 220 receives the reference signal at resource element positions indicated in the specific reference signal configurations for the received respective REGs and decodes the received reference signal with precoding vectors applied to the respective REGs.

Here, the block diagrams for use in the above description of embodiments show blocks for functional units. These functional blocks (components) are implemented in any combination of hardware and/or software items. Also, the implementations of the respective functional blocks are not particularly limited. In other words, the respective functional blocks may be implemented in a physically and/or logically coupled single device or in multiple devices where two or more physically and/or logically separated devices are connected directly and/or indirectly (for example, in wired and/or wireless manners).

For example, the base station 100 and the user apparatus 200 according to one embodiment of the present invention may function as a computer processing the radio communication method according to the present invention. FIG. 15 is a block diagram for illustrating a hardware arrangement of the base station 100 and the user apparatus 200 according to one embodiment of the present invention. The base station 100 and the user apparatus 200 as stated above may each be physically arranged as a computer device including a processor 1001, a memory 1002, a storage 1003, a communication device 1004, an input device 1005, an output device 1006, a bus 1007 or the like.

Note that the language “apparatus” can be interchangeably read as a circuit, a device, a unit or the like. The hardware arrangement of the base station 100 and the user apparatus 200 may each be arranged to include one or more of the illustrated devices or without including a part of the devices.

Respective functions in the base station 100 and the user apparatus 200 are implemented by loading a predetermined software item (program) into hardware items such as the processor 1001 and the memory 1002 to cause the processor 1001 to execute operations, perform communication with the communication device 1004 and control read and/or write operations on data from/in the memory 1002 and the storage 1003.

The processor 1001 runs an operating system to control the whole computer, for example. The processor 1001 may be arranged with a central processing unit (CPU) including an interface with a peripheral device, a control device, a calculation device, a register and the like. For example, the above-stated components may be implemented in the processor 1001.

Also, the processor 1001 loads programs (program codes), software modules and data from the storage 1003 and/or the communication device 1004 into the memory 1002 and executes various operations in accordance with them. As the programs, programs for causing the computer to perform at least a part of operations as described in the above embodiments are used. For example, operations by the components in the base station 100 and the user apparatus 200 may be implemented with control programs stored in the memory 1002 and executed by the processor 1001, and other functional blocks may be similarly implemented. It has been described that the above-stated various operations are performed by the single processor 1001, but they may be performed with two or more processors 1001 simultaneously or sequentially. The processor 1001 may be implemented with one or more chips. Note that the programs may be transmitted from a network via an electric communication line.

The memory 1002 is a computer-readable storage medium and may be arranged with at least one of a ROM (Read Only Memory), an EPROM (Erasable Programmable ROM), an EEPROM (Electrically Erasable Programmable ROM), a RAM (Random Access Memory) or the like, for example. The memory 1002 may be referred to as a register, a cache, a main memory (main storage device) or the like. The memory 1002 can store programs (program codes), software modules or the like that can be executed to implement the radio communication method according to one embodiment of the present invention.

The storage 1003 is a computer-readable storage medium and may be arranged with at least one of an optical disk such as a CD-ROM (Compact Disc ROM), a hard disk drive, a flexible disk, a magnetic optical disk (for example, a compact disk, a digital versatile disk, a Blu-ray (registered trademark) disk), a smart card, a flash memory (for example, a card, a stick, a key drive), a floppy (registered trademark), a magnetic strip or the like. The storage 1003 may be referred to as an auxiliary storage device. The above-stated storage medium may be a database or a server including the memory 1002 and/or the storage 1003 or any other appropriate medium.

The communication device 1004 is a hardware item (transceiver device) for communication over computers via a wired and/or wireless network and may be also referred to as a network device, a network controller, a network card, a communication module or the like. For example, the above-stated components may be implemented in the communication device 1004.

The input device 1005 is an input device for receiving external inputs (for example, a keyboard, a mouse, a microphone, a switch, a button, a sensor or the like). The output device 1006 is an output device for providing external outputs (for example, a display, a speaker, a LED ramp or the like). Note that the input device 1005 and the output device 1006 may be integrally arranged (for example, a touch panel).

Also, the respective devices such as the processor 1001 and the memory 1002 are connected with each other via the bus 1007 for communicating information. The bus 1007 may be arranged with a single bus or different buses for different devices.

Also, the base station 100 and the user apparatus 200 may be arranged to include a hardware item such as a macro processor, a digital signal processor (DSP), an ASIC (Application Specific Integrated Circuit), a PLD (Programmable Logic Device), a FPGA (Field Programmable Gate Array) or the like, and a part or all of the functional blocks may be implemented in the hardware item. For example, the processor 1001 may be implemented with at least one of these hardware items.

Transmission of information is not limited to the embodiments/implementations as described in the present specification and may be made in any other manner. For example, information may be transmitted in physical layer signaling (for example, DCI (Downlink Control Information) and UCI (Uplink Control Information)), upper layer signaling (for example, RRC (radio Resource Control) signaling, MAC (medium Access Control) signaling, broadcast information (MIB (master Information Block) and SIB (System Information Block)) or any other signal or combinations thereof. Also, the RRC signaling may be referred to as an RRC message and may bean RRC Connection Setup message, an RRC Connection Reconfiguration message or the like.

The respective embodiments/implementations as described in the present specification may be applied to systems using LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA 2000, UMB (Ultra Mobile Broadband), IEEE 802.11 (Wi-Fi), IEEE 802.16 (WiMAX), IEEE 802.20, UWB (Ultra-WideBand), Bluetooth (registered trademark) or any other appropriate system or next-generation systems enhanced based on them.

Procedures, sequences, flowcharts or the like of the respective embodiments/implementations as described in the present specification may be permutable, as long as there is not inconsistency. For example, for methods as described in the present specification, various steps are presented in an exemplary order, and the present invention is not limited to the presented certain order.

Certain operations performed by the base station 100 as described in the present specification may be performed by its upper node in some cases. In a network including one or more network nodes having base stations, various operations performed to communicate with terminals may be apparently performed by the base stations and/or network nodes other than the base stations (for example, a MME or an S-SW can be assumed, but the network nodes are not limited to them). Although it has been described that the single network node other than the base stations is used in the above example, combinations of multiple other network nodes (for example, an MME and an S-GW) may be used.

Information and others may be output from an upper layer (or a lower layer) to a lower layer (or an upper layer). They may be input and output via multiple network nodes.

Incoming and outgoing information and others may be stored in a certain location (for example, a memory) and/or managed in a management table. The incoming and outgoing information and others may be overwritten, updated or added. The outgoing information and others may be deleted. The incoming information and others may be transmitted to other device.

Determination may be made with a one-bit value (0 or 1), a Boolean value (true or false) or numerical comparison (for example, comparison with a predetermined value).

The embodiments/implementations as described in the present specification may be used singularly or in combinations or switched in connection with execution. Also, indication of predetermined information (for example, indication “it is X”) is not limited to explicit manners and may be performed implicitly (for example, the predetermined information is not indicated).

Although the present invention has been described in detail, it is apparent to those skilled in the art that the present invention is not limited to the embodiments as described in the present specification. The present invention can be implemented as modifications and variations without departing from the sprit and scope of the present invention as defined in claims. Thus, the description in the present specification is intended for exemplary description and does not mean any restriction to the present invention.

Software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function or the like regardless of the software being referred to as software, a firmware, a middleware, a microcode, a hardware descriptive language or other names.

Also, the software, the instruction or the like may be transmitted and received via a transmission medium. For example, if the software is transmitted from a website, a server or other remote sources by using wired techniques such as a coaxial cable, an optical fiber cable, a twist pair and a digital subscriber line (DSL) and/or wireless techniques such as infrared, radio frequency and microwave, these wired techniques and/or wireless techniques are included within definition of a transmission medium.

Information, signals or the like as described in the present specification may be represented with use of any of various different techniques. For example, data, an instruction, a command, information, a signal, a bit, a symbol, a chip and so on referred to throughout the above description may be represented with a voltage, a current, an electromagnetic wave, a magnetic field, a magnetic particle, an optical field, a photon or any combination thereof.

Note that terminologies described in the present specification and/or terminologies required to understand the present specification may be replaced with terminologies having the same or similar meanings. For example, a channel and/or a symbol may be a signal. Also, the signal may be a message. Also, a component carrier (CC) may be referred to as a carrier frequency, a cell or the like.

The terminologies “system” and “network” for use in the present specification are interchangeably used.

Also, information, a parameter and so on as described in the present specification may be represented with an absolute value, a relative value from a predetermined value or other corresponding information. For example, a radio resource may be specified with an index.

Names as used for the above-stated parameters are not restrictive from any standpoint. Furthermore, there are some cases where formulae and so on using these parameters may be different from ones as explicitly disclosed in the present specification. Various channels (for example, a PUCCH, a PDCCH or the like) and information elements (for example, a TPC or the like) can be identified with any preferred names, and the various names assigned to these various channels and information elements are not restrictive from any standpoint.

A base station can accommodate one or more (for example, three) cells (also referred to as sectors). If the base station accommodates multiple cells, the whole coverage area of the base station can be segmented into multiple smaller areas, and the respective smaller areas can provide communication services with a base station subsystem (for example, indoor small base station RRH: Remote Radio Head). The terminology “cell” or “sector” indicates a part or whole of the coverage area of the base station providing communication services in the coverage and/or the base station subsystem. Furthermore, the terminologies “base station”, “eNB”, “cell” and “sector” can be interchangeably used in the present specification. The base station may be referred to as terminologies such as a fixed station, a NodeB, an eNodeB (eNB), an access point, a femtocell and a small cell.

A mobile station may be referred to by those skilled in the art as a subscriber station, a mobile unit, a subscriber unit, a wireless unit, a remote unit, a mobile device, a wireless device, a wireless communication device, a remote device, a mobile subscriber station, an access terminal, amobile terminal, a wireless terminal, a remote terminal, a handset, a user agent, a mobile client, a client or any other appropriate terminologies.

There are some cases where terminologies “determining” as used in the present specification may include various operations. The “determining” may include calculating, computing, processing, deriving, investigating, looking up (for example, looking up a table, a database or other data structures) and ascertaining, for example. Also, the “determining” may include receiving (for example, receiving information), transmitting (for example, transmitting information), inputting, outputting and accessing (for example, accessing data in a memory). Also, the “determining” may include resolving, selecting, choosing, establishing, comparing or the like. In other words, the “determining” may include any operation.

The terminologies “connected”, “coupled” or all variations thereof mean direct or indirect connection or coupling between two or more elements and can include existence of one or more intermediate elements between two mutually “connected” or “coupled” elements. The coupling or connection between elements may be physical, logical or in combinations thereof. If they are used in the present specification, it can be considered that two elements are mutually “connected” or “coupled” with use of one or more electric wires, cables and/or print electric connections and as several non-limiting and non-comprehensive examples, with use of electromagnetic energy such as electromagnetic energy having a wavelength of a radio frequency domain, a microwave domain and an optical (both visible and invisible) domain.

A reference signal can be omitted as a RS (Reference Signal) and may be referred to as a pilot depending on applied standards.

The recitation “based on” as used in the present specification does not mean “only based on”, unless specifically stated otherwise. In other words, the recitation “based on” means both “only based on” and “at least based on”.

Any reference to elements with use of terminologies such as “first”, “second” and soon as used in the present specification does not limit the amount or order of these elements in general. These terminologies can be used in the present specification as convenient manners for distinguishing between two or more elements. Accordingly, the reference to the first and second elements does not mean that only the two elements are used there or the first element has to precede the second element in any fashion.

The terminology “means” in an arrangement of each apparatus as stated above may be replaced with “unit”, “circuit”, “device” or the like.

As long as the terminologies “include”, “including” and variations thereof are used in the present specification or claims, these terminologies are intended to be inclusive similar to the terminology “comprising”. Furthermore, the terminology “or” as used in the present specification or claims is intended not to be an exclusive OR.

A radio frame may be arranged with one or more frames in a time domain. In the time domain, one or more frames each may be referred to as a subframe. The subframe may be further arranged with one or more slots in the time domain. The slot may be further arranged with one or more symbols (OFDM symbols, SC-FDMA symbols and so on) in the time domain. Any of the radio frame, the subframe, the slot and the symbol represents a time unit for transmitting signals. The radio frame, the subframe, the slot and the symbol may be referred to in other corresponding manners. For example, in LTE systems, a base station performs scheduling to assign radio resources (frequency bandwidths, transmission power and so on available in the mobile station) to mobile stations. The minimum time unit for scheduling may be referred to as a TTI (Transmission Time Interval). For example, one subframe, multiple contiguous subframes or one slot may be referred to as the TTI. A resource block (RB) may be a resource assignment unit in the time domain and the frequency domain and may include one or more contiguous subcarriers in the frequency domain. Also, in the time domain, the resource block may include one or more symbols and have one slot, one subframe or one TTI in length. The single TTI and subframe each may be arranged with one or more resource blocks. The above-stated arrangement of radio frame is merely exemplary, and the number of subframes in the radio frame, the number of slots in the subframe, the number of symbols and resource blocks in the slot and the number of subcarriers in the resource block can be changed in any manner.

Although the embodiments of the present invention have been described in detail, the present invention is not limited to the above-stated specific embodiments, and various modifications and variations can be made within the spirit of the present invention as recited in claims.

This patent application is based on and claims priority to Japanese Patent Application No. 2017-019117 filed on Feb. 3, 2017, the entire contents of which are hereby incorporated by reference.

### LIST OF REFERENCE SYMBOLS

10 radio communication system
100 base station
110 communication control unit
120 reference signal processing unit
200 user apparatus
210 communication control unit
220 reference signal processing unit

1. A base station, comprising:
a communication control unit configured to control radio communication with a user apparatus; and
a reference signal processing unit configured to indicate a reference signal configuration for each resource assignment unit to the user apparatus and transmit a reference signal to the user apparatus in accordance with the indicated reference signal configuration.

2. The base station as claimed in claim 1, wherein the communication control unit applies a same transmission precoding to the respective resource assignment units.

3. The base station as claimed in claim 1, wherein the reference signal processing unit applies a same reference signal configuration to the respective resource assignment units.

4. The base station as claimed in claim 3, wherein the communication control unit applies different transmission precodings to the respective resource assignment units.

5. The base station as claimed in claim 1, wherein the reference signal processing unit further indicates a precoding granularity to the user apparatus.

6. A user apparatus, comprising:
a communication control unit configured to control radio communication with a base station; and
a reference signal processing unit configured to receive a reference signal configuration for each resource assignment unit indicated from the base station and receives a reference signal transmitted in accordance with the received reference signal configuration.

7. The user apparatus as claimed in claim 6, wherein the reference signal processing unit receives the reference signal for which a same transmission precoding is applied to respective resource assignment units.

8. The user apparatus as claimed in claim 6, wherein the reference signal processing unit receives the reference signal for which a same reference signal configuration is applied to respective resource assignment units.

9. The user apparatus as claimed in claim 8, wherein the reference signal processing unit receives the reference signal for which different transmission precodings are applied to resource assignment units.

10. The user apparatus as claimed in claim 6, wherein the reference signal processing unit receives the reference signal transmitted in accordance with a precoding granularity indicated from the base station.

11. The base station as claimed in claim 2, wherein the reference signal processing unit further indicates a precoding granularity to the user apparatus.

12. The base station as claimed in claim 3, wherein the reference signal processing unit further indicates a precoding granularity to the user apparatus.

13. The base station as claimed in claim 4, wherein the reference signal processing unit further indicates a precoding granularity to the user apparatus.

14. The user apparatus as claimed in claim 7, wherein the reference signal processing unit receives the reference signal transmitted in accordance with a precoding granularity indicated from the base station.

15. The user apparatus as claimed in claim 8, wherein the reference signal processing unit receives the reference signal transmitted in accordance with a precoding granularity indicated from the base station.

16. The user apparatus as claimed in claim 9, wherein the reference signal processing unit receives the reference signal transmitted in accordance with a precoding granularity indicated from the base station.
